(19) United States
(12) Patent Application Publication
(10) Pub. No.: US 2002/0005387 A1
(43) Pub. Date: Jan. 17, 2002

(54) Systems and methods for removing solids from a fluid environment

(76) Inventor: Neil E. Helwig, Mason, OH (US)

Correspondence Address: FOLEY, HOAG & ELIOT, LLP, PATENT GROUP, ONE POST OFFICE SQUARE, BOSTON, MA, 02109, US

(21) Appl. No.: 09/842,594

(22) Filed: Apr. 26, 2001

Related U.S. Application Data
(60) Provisional application No. 60/199,882, filed on Apr. 26, 2000.

(51) Int. Cl. B01D 17/038

(52) U.S. Cl. 210/787; 210/512.1; 210/538

(57) ABSTRACT

A system and method for removing solids from a fluid environment. The system includes a device for separating solids fluid using cyclonic flow. The device includes column for collecting solids to be separated from the fluid environment. The device also includes a plenum positioned circumferentially about a lower end of the column and an inlet in tangential communication with the plenum for generating a cyclonic flow pattern into the column. As the cyclonic flow is introduced into the column, the annulus directs the solids in suspension upwards and towards the center of the column. The velocity of the flow upward is sufficiently less than the settling velocity of the solids thereby allowing the solids to fall out of suspension. The ascending fluid substantially free of solids can be collected through an upper end of the column. The device further includes a draining assembly for collecting the settled solids and for removing the solids therethrough.

### RELATED U.S. APPLICATION(S)

This application claims priority to U.S. Provisional Application Ser. No. 60/199,882, filed Apr. 26, 2000, which application is hereby incorporated herein by reference.

### FIELD OF THE INVENTION

The present invention relates to systems and methods for facilitating the separation of solids from a fluid environment, and more particularly systems and methods which employ cyclonic flow to separate solids from a fluid environment.

### BACKGROUND ART

Solids are typically classified by using three different criteria, size, state and chemical characteristic. In addition, solids may be differentiate by one of four size categories:

Dissolved Solids are defined by having a size of less than 10⁻⁶ mm and are composed of ions and molecules that are present in the solution.

Colloidal Solids are defined by having a diameter between about 10⁻³ to 10⁻⁶ mm. These solids include many fine clay particles, virus and some bacteria.

Suspended Solids (non-filtrable) are defined by having a size greater than about 10⁻³ mm and can be trapped by a 1.2 micron filter.

Settleable Solids are a subsection of suspended solids that will settle out of solution, when left un-agitated, for instance, in an Imhoff cone, for about one hour.

Solids can be removed from solution in many ways. One of the most common is physical filtration. Physical filtration includes the use of filters, such as screens, bags, pleated cartridges, etc., and the use of gravity separators, such as sedimentation, centrifuging, and hyrodcloning. Gravity separators are normally much more passive than screen filters, but normally only remove large particles and are subject to changes in efficiency due to solid and water characteristics.

In treating fluids with suspended solids, one of the most effective methods employed is the use of a tank as a primary settling device. The basic treatment principle is to slow the fluid velocity within the tank to a point where solids can fall out of suspension and drop to the bottom of the tank.

One environment in which the use of a settling device can be particularly effective is waste water treatment. In a wastewater treatment environment, a clarifier is often used to accomplish solid separation. Specifically, a clarifier uses a mechanical arm that rotates slowly around, for example, a cylindrical tank to direct suspended solids toward the center of fluid flow within the tank, where the solids may subsequently fall out of suspension near the center of the tank. The solids may thereafter be removed through an outlet port at the bottom of the tank. The clarified water may be removed through an overflow weir at the top perimeter of the tank.

Another environment in which the use of a settling device can be particular effective is aquaculture. In an aquaculture environment, it is important that solids, such as wastes from the aquatic animals (e.g., fish), be removed from the water. In particular, if the solids are allowed to remain in the water, the solids will decompose, leading to the consumption of oxygen and creation of compounds, such as hydrogen sulfide, which can be toxic to the animals. Accordingly, by providing a clean aquaculture environment, i.e., substantially free of wastes, relatively healthier animals may be assured. To generate a substantially clean aquaculture environment for the animals living therein, a holding, or grow-out, tank with effective solids removal mechanisms has been used.

There are currently two commonly used methods for removal of solids from a grow-out tank. One method employs running 100% of the water flow, along with the suspended solids, through a solids filter, such as a rotating drum filter or other types of filter, so that the solids may be separated from the water. A disadvantage with this method is that it is capital and labor intensive. Specifically, the expense associated with buying the filter, as well as the cost of parts and labor related to maintenance of the equipment of this size and complexity can be substantial.

Another method employs a “Dual Drain” approach, wherein the principles of a clarifier is applied. In this approach, the majority of the water flow (containing a small percentage of solids) is removed through a side drain near the top of the tank. The remainder of the water flow (containing a high percentage of the solids concentrated near the center at the bottom of the tank) is removed through a center drain at the bottom of the tank.

In some clarifier designs, instead of using a mechanical arm to concentrate solids falling out of the suspension, circular flow is employed. With such designs, circular flow is induced in the tank by bringing a water inlet pipe over the top of the tank with a manifold that is provided with outlet orifices situated near the wall of the tank. The water exiting the outlet orifices are forced against the wall of the tank causing a circular flow pattern. This circular flow generates a hydraulic effect, which is typically referred to as a “Tea Cup Effect”, and causes the solids that have fallen out of the suspension to be swept along the bottom of the tank towards the center. However, since the inlet is positioned only in one area, the flow pattern is often not symmetrical and can be easily disturbed by the animals. As a result, there often can be a problem with concentrating the solids in the center of the tank.

Accordingly, it would be desirable to provide a system which can efficiently and inexpensively handle the settling, moving and removal of solids. The system preferably can be employed in an aquaculture environment as a grow-out tank, as well as in a wastewater treatment environment as a clarifier.

### SUMMARY OF THE INVENTION

The present invention provides, in one embodiment, a device for removing solids from a fluid environment, such as water or gas. The device, in accordance with an embodiment, includes a substantially cylindrical column for collecting solids to be separated from the fluid environment. The device also includes a plenum positioned circumferentially about a lower end of the column for generating a cyclonic flow pattern within the column, so that solids separated from the fluid environment (i.e., fallen out of suspension) can be directed towards a central location within the column. To generate a cyclonic flow pattern, an inlet may be positioned tangentially to the plenum to introduce fluid into the plenum. In this manner, the fluid introduced through the inlet may follow a cyclonic path within the plenum and around the column. An annulus may be provided at an area between the lower end of the column and the plenum to provide an opening through which the cyclonic flow may exit the plenum and flow upwardly into the column. The device is designed so that the rate of fluid flow upward is less than the rate of solids falling out of suspension, so that the fluid at the upper portion of the column is substantially free of solids. The device may further include an overflow weir positioned about an upper portion of the column to collect overflowing fluid that is substantially free of solids, as the fluid rises from within the column. Alternatively, an overflow outlet may be provided in place of the overflow weir to remove fluid from the column. The overflow outlet, in one embodiment, may include a controller to regulate outflow of fluid from within the column. The overflow outlet may also include a mechanism on the controller to interrupt the outflow, so as to minimize generation of a vacuum environment within the controller. The device may further include a draining assembly provided at a bottom surface of the plenum for removal of solids accumulated at the central location within the column.

The present invention also provides a method for removing solids from a fluid environment. The method includes generating a uniform upwardly moving cyclonic flow pattern from a fluid environment having a suspension of solids. In one embodiment, the cyclonic flow pattern may be generated by imparting a cyclonic path at the bottom of the cyclonic flow pattern, such that fluid near the bottom of the cyclonic flow pattern is permitted to ascend in a manner substantially transverse to the cyclonic flow pattern. Thereafter, the solids in suspension may be permitted to separate from the cyclonic flow and settle towards the bottom of the flow pattern, leaving the ascending fluid substantially free of solids. The settling of the solids can occur by allowing the ascending fluid to move at a velocity that is less than the velocity of the settling solids. The ascending fluid that is substantially free of solids can be removed, while the settled solids may be directed to move towards a central location of the flow pattern, so as to permit the solids to accumulate thereat. The accumulated solids can subsequently be removed.

In accordance with another embodiment of the present invention, the device for removing solids may be used to remove solids from a fluid source having a suspension of solids. The fluid source may be introduced through a plenum of the device to impart a cyclonic flow. Thereafter, the fluid is permitted to exit from the plenum through an annulus an interior chamber of the device. As the fluid ascend upwardly along the interior chamber, solids in the ascending fluid are allowed to separate and settle towards the bottom of the interior chamber. The fluid substantially free of solids are thereafter removed through the upper end of the column, while the settled solids are directed toward central location of the column for subsequent removal.

The device of the present invention may alternatively be used as a container of fluid having a suspension of solids and which container may also be adapted to remove solids. Initially, a fluid source, different from the fluid (native fluid) in the device, may be introduced through a plenum of the device to impart a cyclonic flow. Thereafter, the source fluid is permitted to exit from the plenum through an annulus into an interior chamber of the device and mix with the native fluid. As the new fluid mixture ascend upwardly along the interior chamber, solids in the ascending fluid mixture are allowed to separate and settle towards the bottom of the interior chamber. The fluid mixture substantially free of solids are thereafter removed through the upper end of the column, while the settled solids are directed toward central location of the column for subsequent removal.

### BRIEF DESCRIPTION OF THE DRAWINGS

FIG. 1 illustrates a device for removing solids from a fluid environment, in accordance with one embodiment of the present invention.

FIG. 2 illustrates a device for removing solids from a fluid environment, in accordance with another embodiment of the present invention.

FIG. 3 illustrates a drain assembly for use with the device illustrated in FIGS. 1 and 2.

### DESCRIPTION OF SPECIFIC EMBODIMENTS

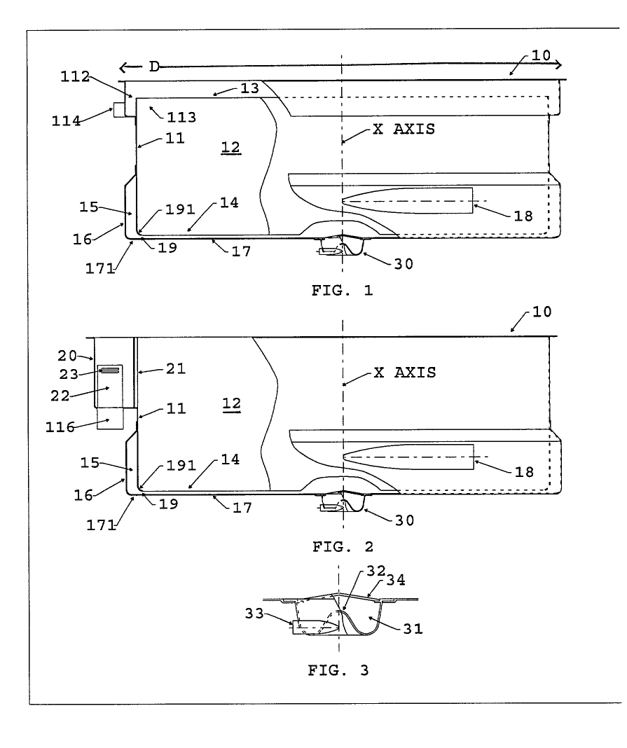

Referring now to the drawings, FIG. 1 illustrates, in accordance with one embodiment, a device 10 for removing solids from a fluid environment, such as liquid or gas. The device 10 includes a column 11, which column may be provided with an interior chamber 12 extending between a first end 13 and a second end 14 of the column 11. The column 11, in an embodiment of the invention, may be cylindrical in shape along its entire length for containing the fluid environment and for collecting solids to be separated from the fluid environment. Although shown to be substantially cylindrical, it should be appreciated that the column 11 may be provided with any geometrical shape along its length, so long as the shape permits the column 11 to maintain the fluid environment therein and to collect solids to be separated from the fluid environment. The device 10 also includes a plenum 15 for receiving fluid introduced into the device 10. The plenum 15, in one embodiment, may be positioned circumferentially about the second end 14 (i.e., lower end) of the column 11 and includes a bottom surface 17 extending across a lower end 171 of the plenum 15. In this manner the plenum 15 may be provided with a diameter that is larger relative to a diameter of column 11. It should be appreciated that although the plenum 15 is illustrated in FIG. 1 as being positioned about an exterior of the column 11, the plenum 15 may alternatively be positioned circumferentially about the interior chamber 12 with a diameter that is smaller relative to a diameter of column 11. The plenum 15 may be configured to induce a substantially uniform cyclonic flow pattern to the fluid introduced into the plenum. In particular, as fluid is introduced into the plenum 15, the fluid is directed along plenum wall 16, causing the fluid to flow at a substantially uniform velocity circumferentially about the column 11. It should be noted that the plenum 15 does not necessarily have to have a constant diameter from its top to its lower end 171. However, its configuration should permit the plenum 15 to maintain a cyclonic flow pattern of substantially uniform velocity.

To introduce fluid into the plenum 15, an inlet 18 may be provided. The inlet 18, in an embodiment, may be situated in tangential communication with the plenum 15. The tangential position of the inlet 18 relative to the plenum 15 permits the fluid entering into the plenum 15 to flow along the wall of the plenum, resulting in a cyclonic flow pattern circumferentially about the column 11. The device 11 may further include an annulus 19 defined at an area between the second end 14 of the column 11 and the bottom surface 17 of the plenum 15, so as to provide an opening through which fluid communication may occur between the plenum 15 and the interior chamber 12. The annulus 19, in a preferred embodiment, is provided with a dimension sufficient to allow fluid which exit therethrough to be uniformly distributed about the interior chamber 12.

A flow director 191, still referring to FIG. 1, may be provided along the annulus 19 to facilitate the flow of fluid from the plenum 15 into the interior chamber 12. In one embodiment of the invention, the flow director 191 may be placed along an entire circumference of the annulus 19 to direct the flow of fluid toward a central location within the interior chamber 12 through which axis X extends. The flow director 191 may also help to facilitate the transition of fluid flow from the plenum 15 into the interior chamber 12 by permitting the fluid to follow a relatively laminar flow pattern along the director 191 into the interior chamber 12. By allowing the fluid flow to follow a relatively laminar pathway, the amount of turbulent flow into the interior chamber 12 may be reduced. With a reduction in turbulent flow, fluid entering the interior chamber 12 may approximate a “plug-flug” pattern as it travels up along column 11. In other words, along any cross-sectional portion across the interior chamber, the rate of flow moves substantially uniformly upward along the column 11. It should be appreciated that although the flow across the annulus 19 may be relatively laminar, the direction of the fluid flow into the interior chamber 12 may still follow a cyclonic pattern upward along the interior chamber 12.

As fluid flows upwardly along the interior chamber 12, fluid within upper portion 113 near the first end 13 of column 11 may be pushed into an overflow weir 112 (i.e., a trough). The presence of the overflow weir 112 about the first end 13 of the column 11 permits the level of fluid within the interior chamber 12 to be maintained below a point of overspill. The overflow weir 112 may be configured to include a diameter D that is measurably larger than that of the column 11. In this manner, as fluid rises from within the interior chamber 12, the fluid may be pushed over the first end 13 of the column 11 into the overflow weir 112 for collection. The first end 13 of the column 11, as illustrated in FIG. 1, may be substantially even around the column 11. However, should it be desired, the first end 13 may be manufactured to include an undulating or serrated design (not shown). By providing the first end 13 with an undulating or serrated design (one with peaks and valleys), a uniform pattern of fluid overflow at the first end 13 into the overflow weir 112 may be generated in the event that the column 11 is not level, so as to minimize the velocity of the overflow into the weir 112, and the pulling of any solids into the weir 112 from within the interior chamber 12.

The overflow weir 112 may be provided with an overflow outlet 114, through which fluid from within the weir 112 may be removed. The outlet 114 can be coupled to, for instance, a pipe (not shown) to provide a pathway along which fluid may be directed from the weir 112. Although one outlet 114 may be sufficient, it should be appreciated that multiple outlets 114 may be provided to facilitate removal of fluid from the weir 112.

Looking now at FIG. 2, in an alternate embodiment, rather than an overflow weir 112, a overflow box 20 may be provided at the first end 13 of the column 11 to regulate the outflow of fluid from the interior chamber 12 and the level of fluid within the interior chamber 12. The overflow box 20 may include, in one embodiment, an opening 21 through which fluid from the interior chamber 12 may flow. The size of the opening 21 should be sufficient to minimize the velocity of fluid flow into the box 20, and the pulling of any solids into the box 20 from within the interior chamber 12. If desired, a screen may be placed across the opening 21 to prevent solids from within the interior chambers from flowing into the box 20. The box 20 may also include an outlet 116 for directing fluid from box 20. In one embodiment, a controller, for example, pipe 22, may be provided through which fluid within the box 20 may be directed into outlet 116. The pipe 22, in a preferred embodiment, may be adjustable, so as to permit variation in its height within the box 20. By allowing the pipe 22 to be variable in its height, fluid level within the interior chamber 12 may be permitted to approximate a height level of the pipe 22 in the box 20. To this end, the level of fluid within the interior chamber 12 may be controlled (i.e., increased or lowered), and the amount of outflow of fluid from within the interior chamber 12 may be regulated. The amount of outflow from within the interior chamber 12 may further be regulated by the diameter of the opening of pipe 22. That is, the larger the opening, the more outflow through the pipe 22 will result. In one embodiment, pipe 22 may be designed to include slits 23 or other apertures on its side wall to interrupt the flow of fluid pipe 22, as at time, it may be desirable to minimize a vacuum environment generated by the outflow of fluid through the pipe 22. Pipe 22 may be connected to, for instance, a tube (not shown) to provide a pathway along which fluid may be directed from the box 20.

Referring now to FIG. 3, the device 10 may include a draining assembly 30 positioned at the bottom surface 17 of the plenum 15 for removing solids accumulated within the interior chamber 12 of column 11. The draining assembly 30, in one embodiment, includes a substantially circular concavity 31 within which solids may accumulate. Accumulation of solids may be generated from acceleration of cyclonic fluid flow along the bottom surface 17 of the plenum 15 the into the concavity 31. Although shown to be substantially circular, the concavity 31 may be designed to include other geometrical patterns which approximate a circular shape, for instance a hexagon etc., to permit the maintenance of cyclonic flow from within the interior chamber 12 into the concavity 31. To further enhance accumulation of solids within the concavity 31, a substantially conical projection 32 may be positioned within the concavity 31. The projection 32 acts to localize cyclonic flow pattern within the interior chamber 12 to draw accumulated solids into the concavity 31. In an embodiment of the invention, the projection 32 is provided with a height that is not substantially higher than the top of the concavity 31.

The draining assembly 30 may further include a drain outlet 33 in communication with the concavity 31 to permit removal of solids from within the concavity 31. The drain outlet 33, in one embodiment, may be placed in tangential communication with the concavity 31 to accommodate the outflow of fluid and solids moving in a cyclonic flow pattern within the concavity 31. As there may be materials within the interior chamber 12 which are not to be removed through the draining assembly 30, a perforated cover 34 may be provided for placement across the concavity 31 to prevent such materials from being removed.

In operation, the device 10 of the present invention may have various applications, including being used as a clarifier.

As a clarifier, the device 10 may be used to separate a suspension of solids in a fluid environment received from a source. Initially, fluid having the suspension of solids may be directed from a source through the inlet 18 of device 10 and into the plenum 15. As the fluid is introduced through the inlet 18, the tangential placement of the inlet 18 relative to the plenum 15 causes the fluid to flow along the wall of the plenum 15 circumferentially about the column 11. By directing the fluid to flow along the wall of the plenum 15, a cyclonic flow pattern may be imparted within the plenum 15. The cyclonic flow, thereafter, continues to move downward toward the annulus 19, and subsequently exits through the annulus into the interior chamber 12 of the device 10. As the fluid moves across the annulus 19, the fluid is uniformly distributed into the interior chamber 12, and ascends upwardly in a plug-flow pattern along with the suspended solids, while maintaining its cyclonic characteristic. The cyclonic characteristic of fluid flow within the interior chamber 12 helps, to a certain extent, in directing the suspended solids towards axis X at the center of the interior chamber 12. As the fluid, along with the suspended solids, continues to move upwardly into the interior chamber 12, the suspended solids are subsequently forced by gravity to separate from the fluid and slowly fall out of suspension to settle towards the bottom surface 17. In order to permit gravity to act on the suspended solids and cause the solids to fall out of suspension, the plenum 15, in one embodiment, is designed so that fluid moving across the annulus 19 is provided with an ascending velocity that is less than the settling velocity of the solids caused by gravity. The ascending fluid which is substantially free of solids may continue to rise toward the first end 13 of the column 11 and subsequently collected within, for example, an overflow weir 112 or an overflow box 20 and removed from the device 10.

As the majority of the suspended solids is directed by the cyclonic flow towards the center of the interior chamber 12, the accumulation of settling solids on the bottom surface 17 is typically near the center of the interior chamber 12. However, there may be some solids which have settled along the bottom surface 17 substantially away from the center of the interior chamber 12. For those solids, the outflow of fluid from within the plenum 15 across the annulus 19 can cause to push those solids relatively close to the center of the interior chamber 12 along the bottom surface 17, while resuspending those solids relatively far from the center of the interior chamber 12 back into cyclonic flow. The cyclonic flow can thereafter redirect those resuspended solids towards the center of the interior chamber 12 for subsequent settling towards the bottom surface 17.

Once the solids are accumulated on the bottom surface 17 near the center of the interior chamber 12, the solids may be removed, for instance, through the draining assembly 30. As discussed above, the draining assembly 30 can act, by the outflow of fluid through the drain outlet 33, to increase the cyclonic flow within the interior chamber 12 to pull the solids near the center of the interior chamber 12 into the concavity 31. Once collected within the concavity 31, the solids may be removed through the drain outlet 33. It should be appreciated that the draining assembly 30, in one embodiment, may be designed so that the amount of fluid removed through the drain outlet 33 can be adjusted to regulate the velocity of the cyclonic flow within the interior chamber 12 and thus the accumulation of solids within the concavity 31. For instance, by increasing the outflow through the drain outlet 33, the rate of accumulation of solids in the concavity 31 increases. Alternatively, by decreasing the outflow through the drain outlet 33, the rate of accumulation of solids in the concavity 31 decreases. However, in a preferred embodiment, the amount of outflow through the drain outlet 33 should be at a rate which minimizes fluid removal while maximizes solids accumulation. In this manner, an optimal amount of fluid substantially free of solids within the interior chamber 12 can be maintained for removal through the first end 13 of the column 11.

Despite providing a draining assembly 30 for removal of solids, it should be noted that the device of the present invention may operate to remove solids without a draining assembly 30. In one embodiment, the accumulated solids may be removed by the use of, for example, a vacuum hose introduced through the first end of the column down to the area of solids accumulation.

To further enhance the accumulation and removal of solids from within the interior chamber 12, special attention should be paid to the ratio of the height of the column 11 to the diameter of the column 11. It has been observed that in order to enhance accumulation of solids towards the center of the interior chamber 12, the height of column 11 should be shorter than the diameter of column 11. However, such ratio should nevertheless be determined on a case by case basis in order to establish the optimum rate of accumulation for each device 10.

In accordance with another embodiment of the present invention, the device 10 may be employed as a grow-out tank for use in an aquaculture environment.

As a grow-out tank, the device 10 may be used as a container for housing aquatic animals, such as fish. As a container for aquatic animals, the device 10 can sometime encounter unwanted accumulation of solids, for instance, wastes generated from the aquatic animals. Such wastes must often be removed from the fluid environment in order to maintain a healthy stock of aquatic animals. To remove the solids generated within fluid environment in the device 10, a fluid from a source (hereinafter “source fluid”) different from the fluid contained in the device 10 (hereinafter “native fluid”) may be introduced into the plenum 15 through the tangential inlet 18 to impart a cyclonic flow within the plenum. It should be noted that the device 10 operates herein, in a similar manner discussed above, to remove the suspension of solid materials in the native fluid environment. The one significant difference as a grow-out tank is that the suspension of solids already exists in the device 10 and such suspension is not introduced into the device 10 from a source fluid.

After the source fluid is introduced into the plenum 15, it continues to move downward toward the annulus 19, and subsequently exits through the annulus 19 into the interior chamber 12 of the device 10. As the source fluid moves across the annulus 19, the source fluid is uniformly distributed into the interior chamber 12 and mixes with the native fluid having the suspension of solids. The resulting mixed fluid ascends upwardly in a plug-flow pattern along with the suspended solids, while maintaining its cyclonic characteristic. The cyclonic characteristic of fluid flow within the interior chamber 12 helps to direct the suspended solids towards axis X at the center of the interior chamber 12. As the mixed fluid, along with the suspended solids, continues to move upwardly into the interior chamber 12, gravity acts on the suspended solids to subsequently separate the solids from the fluid and allow the solids to slowly fall out of suspension to settle towards the bottom surface 17. The ascending mixed fluid which is substantially free of solids may continue to rise toward the first end 13 of the column 11 and subsequently collected within, for example, an overflow weir 112 or an overflow box 20 and removed from the device 10.

As the majority of the suspended solids is directed by cyclonic flow towards the center of the interior chamber 12, the accumulation of settling solids on the bottom surface 17 is typically near the center of the interior chamber 12. For those solids that settled away from the center of the interior chamber 12, the outflow of fluid within the plenum 15 can push those solids closer to the center of the interior chamber 12 and/or resuspend the solids for subsequent settling. Once the solids are accumulated on the bottom surface 17 near the center of the interior chamber 12, the draining assembly 30 can act, by the outflow of fluid through the drain outlet 33, to collect the solids within the concavity 31 and remove the solids through the drain outlet 33.

While the invention has been described in connection with specific embodiments thereof, it will be understood that it is capable of further modification. For example, the size of the various components of the device 10 may be modified to accommodate various applications. Furthermore, this application is intended to cover any variations, uses, or adaptations of the invention, including such departures from the present disclosure as come within known or customary practice in the art to which the invention pertains, and as fall within the scope of the appended claims.

What is claimed is:

1. A device for removing solids from a fluid environment, the device comprising:
a substantially cylindrical column for collecting solids to be separated from the fluid environment;
a plenum circumferentially positioned about a lower end of the column for generating a cyclonic flow pattern within the column, so that the solids separated from the fluid environment can be directed towards a central location within the column;
an annulus defined at an area between the lower end of the column and the plenum for fluid communication between the plenum and the column;
an inlet in tangential communication with the plenum to introduce fluid into the plenum;
an overflow weir positioned about an upper portion of the column to collect overflowing fluid substantially free of solids as the fluid rises from within the column.

2. A device as set forth in claim 1, further including an overflow outlet on the overflow weir to permit removal of fluid from the weir.

3. A device as set forth in claim 1, further including a draining assembly positioned at a bottom surface of the plenum for removal of solids from the column.

4. A device as set forth in claim 3, wherein the assembly comprises:
an substantially circular concavity;
a substantially conical projection rising from within the concavity to localize cyclonic acceleration of the fluid flow to draw the solids into the concavity; and
an outlet in communication with the interior of the concavity to permit removal of the solids from within the concavity.

5. A device as set forth in claim 4, further including a perforated cover for placement across the concavity.

6. A device for removing solids from a fluid environment, the device comprising:
a column having an interior chamber extending between a first end and a second end of the column;
a plenum circumferentially positioned about the second end of the column for generating a cyclonic flow pattern within the column, so that the solids separated from the fluid environment can be directed along a bottom surface of the plenum towards a center of the column;
an annulus defined at an area between the second end of the column and the plenum for fluid communication between the plenum and the interior chamber;
an inlet in tangential communication with the plenum through which fluid is introduced into the plenum; and
a drain port through which the separated solids can be removed.

7. A device as set forth in claim 6, further including an overflow outlet positioned at the first end of the column to permit removal of fluid substantially free of solids as the fluid rises from within the column.

8. A device as set forth in claim 7, wherein the overflow outlet includes a controller to regulate outflow of fluid from within the column.

9. A device as set forth in claim 8, wherein the controller includes a mechanism to interrupt outflow, so as to minimize a vacuum environment within the controller.

10. A device as set forth in claim 6, wherein the drain port includes a draining assembly positioned at a bottom surface of the plenum for removal of solids from the column.

11. A device as set forth in claim 10, wherein the assembly comprises:
an substantially circular concavity;
a substantially conical projection rising from within the concavity to localize cyclonic acceleration of the fluid flow to draw the solids into the concavity; and
an outlet in communication with the interior of the concavity to permit removal of the solids from within the concavity.

12. A method for removing solids from a fluid environment, the method comprising:
generating a substantially uniform upwardly moving cyclonic flow pattern from a fluid environment having a suspension of solids;
permitting the solids to separate from the cyclonic flow and settle towards the bottom of the flow pattern;
directing movement of the settled solids towards a central location of the flow pattern, so as to permit the solids to accumulate thereat; and
removing the fluid which is substantially free of the solids.

13. A method as set forth in claim 12, further comprising removing the accumulated solids.

14. A method as set forth in claim 12, wherein the step of generating includes imparting a cyclonic path at the bottom of the cyclonic flow pattern, such that fluid toward the bottom of the cyclonic flow pattern is permitted to ascend in a manner substantially transverse to the cyclonic flow pattern.

15. A method as set forth in claim 14, wherein the step of generating includes allowing the fluid from the bottom of the flow pattern to ascend at a velocity less than a velocity of the settling solids, such that as the fluid approaches the top of the flow pattern, the fluid is substantially free of solids.

16. A method for removing solids from a fluid environment, the method comprising:
providing a device having column and an interior chamber extending between a first end and a second end of the column, a plenum positioned circumferentially about the second end of the column for generating a cyclonic flow pattern within the column, an annulus defined at an area between the second end of the column and the plenum for fluid communication with the interior chamber, and an inlet in tangential communication with the plenum through which fluid is introduced into the plenum;
introducing fluid having a suspension of solids through the inlet, such that its tangential communication with the plenum imparts a cyclonic flow within the plenum;
permitting the fluid to exit from the plenum through the annulus and into the interior chamber, such that the fluid is subject to an upward flow from the second end of the column towards the first end of the column;
allowing the solids to separate from the upwardly flowing fluid and settle towards the second end of column;
directing the settled solids towards a central location of the column, so as to permit the solids to accumulate thereat; and
removing the fluid at the first end of the column which is substantially free of the solids.

17. A method as set forth in claim 16, further comprising removing the accumulated solids.

18. A method as set forth in claim 16, wherein the step of permitting includes subjecting the fluid to ascend upwardly in a plug-flow pattern, in which fluid flows uniformly upward cross-sectionally in a direction substantially transverse to the cyclonic flow pattern.

19. A method as set forth in claim 16, wherein the step of allowing includes causing the upwardly flowing fluid to ascend at a velocity less than a velocity of the settling solids, such that as the fluid approaches the top of the flow pattern, the fluid is substantially free of solids.

20. A method for removing solids from a fluid environment, the method comprising:
providing a device having column and an interior chamber extending between a first end and a second end of the column, a plenum positioned circumferentially about the second end of the column for generating a cyclonic flow pattern within the column, an annulus defined at an area between the second end of the column and the plenum for fluid communication with the interior chamber, and an inlet in tangential communication with the plenum through which fluid is introduced into the plenum;
containing within the interior chamber fluid having a suspension of solids;
introducing fluid from a source through the inlet, such that its tangential communication with the plenum imparts a cyclonic flow within the plenum;
permitting the fluid to exit from the plenum through the annulus and into the interior chamber, such that the fluid having the suspension of solids is subject to an upward cyclonic flow from the second end of the column towards the first end of the column;
allowing the solids to separate from the upwardly flowing fluid and settle towards the second end of column;
directing the settled solids towards a central location of the column, so as to permit the solids to accumulate thereat; and
removing the fluid at the first end of the column which is substantially free of the solids.

21. A method as set forth in claim 20, further comprising removing the accumulated solids.

22. A method as set forth in claim 20, wherein the step of permitting includes subjecting the fluid to ascend upwardly in a plug-flow pattern, in which fluid flows uniformly upward cross-sectionally in a direction substantially transverse to the cyclonic flow pattern.

23. A method as set forth in claim 20, wherein the step of allowing includes causing the upwardly flowing fluid to ascend at a velocity less than a velocity of the settling solids, such that as the fluid approaches the top of the flow pattern, the fluid is substantially free of solids.
